(19) United States
(12) Patent Application Publication
(10) Pub. No.: US 2019/0236738 A1
(43) Pub. Date: Aug. 1, 2019

(54) SYSTEM AND METHOD FOR DETECTION OF IDENTITY FRAUD

(71) Applicant: FST21 Ltd, Rishon Lezion (IL)

(72) Inventors: Hila Lebel, Kfar Saba (IL); Ofir Friedman, Nes Ziona (IL); Yehuda Udy Danino, Givat Shmuel (IL); Rotem Littman, Hod Hasharon (IL); Zohar Bar Yehuda, Givat Shmuel (IL)

(73) Assignee: FST21 Ltd, Rishon Lezion (IL)

(21) Appl. No.: 15/886,017

(22) Filed: Feb. 1, 2018

(51) Int. Cl. G06Q 50/26; G06Q 10/06; G06K 9/00; G06K 9/62; G06T 11/60; G06T 11/00; G06T 7/60

(52) U.S. Cl. CPC G06Q 50/265; G06Q 10/067; G06K 9/00906; G06K 9/00255; G06K 9/6256; G06T 2210/22; G06T 11/001; G06T 7/60; G06K 2009/00328; G06T 2207/30201; G06T 2207/10024; G06T 11/60

(57) ABSTRACT

A system and method for fraud detection may include (a) receiving, by a model based fraud detection unit, a plurality of images related to fraud attempts, (b) determining, by the unit, for each of the images, whether or not the image is related to a fraud attempt, (c) if a percentage of the images identified as related to fraud attempts is lower than a threshold, then automatically modifying at least one coefficient in the model, and repeating steps (a), (b) and (c) until a percentage of the images identified as related to fraud attempts is higher than the threshold.

### FIELD OF THE INVENTION

The present invention relates generally to detecting fraud. More specifically, the present invention relates to an automated system and method for detecting identity related fraud.

### BACKGROUND OF THE INVENTION

Systems and methods for detecting identity fraud are known in the art. Generally, with respect to the technology, an identity fraud involves attempting to convince or deceive a system to grant permission or access to a first person, application or entity disguised, or pretending to be, another, second or different person, application or entity. For example, identity fraud is committed to gain financial advantage, e.g., using a victim's credit card or bank account. In other cases, a fraudster may use another person's image and use it fraudulent activities, e.g., to enter a secured, or restricted area or building.

### SUMMARY OF THE INVENTION

An embodiment for detecting fraud may include the steps of: (a) receiving, by a model based fraud detection unit, a plurality of images related to fraud attempts; (b) determining, by the unit, for each of the images, whether or not the image is related to a fraud attempt; (c) if a percentage of the images identified as related to fraud attempts is lower than a threshold then automatically modifying at least one coefficient in the model; and repeating steps (a), (b) and (c) until a percentage of the images identified as related to fraud attempts is higher than the threshold.

An embodiment may include selecting for repeating steps (a), (b) and (c), a subset of the plurality of images, the subset including images that were not identified as related to fraud attempts. An embodiment may include the steps of: (e) providing, to the detection unit, a plurality of images of real, live persons; (f) determining, by the unit, for each of the images, whether or not the image is of a real, live person; (g) if a percentage of the images identified as images of real, live persons is lower than a threshold then automatically modifying at least one coefficient in the model; and repeating steps (e), (f) and (g) until a percentage of the images identified as images of real, live persons is higher than the threshold. An embodiment may include selecting for repeating steps (e), (f) and (g) a subset of the plurality of images, the subset including images that were not identified as representing real, live persons.

An embodiment may include, prior to repeating steps (a), (b) and (c), modifying attributes of at least some of the plurality of images.

An embodiment may include repeating steps (a), (b) and (c) until, provided with a single image, the fraud detection unit correctly determines whether or not the single image is of a real, live person. An embodiment may include determining an image is of a real, live person; finding, in a database, information related to the person; and performing at least one action based on the information. An embodiment may include performing the at least one action based on identifying the person in one or more previously obtained images related to a fraud attempt.

An embodiment may include training the fraud detection unit by providing, to the fraud detection unit, live recordings obtained by a camera while the camera is mobile in a site. An embodiment may include training the fraud detection unit by providing, to the fraud detection unit, images of printed content. An embodiment may include training the fraud detection unit by providing, to the fraud detection unit, images of a display of a computing device. Modifying attributes of at least some of the plurality of images may include randomly changing at least one of: red, green and blue (RGB) factors, contrast and brightness. Determining, by a fraud detection unit, whether or not the image is related to a fraud attempt may include: cropping similar portions of two or more images of an object; comparing a distance between feature vectors in the portions to a threshold; and if the distance is below the threshold then determining the two or more images are related to a fraud attempt.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of a computing device according to illustrative embodiments of the present invention;

FIG. 2 is an overview of a system according to illustrative embodiments of the present invention; and

FIG. 3 shows a flowchart of a method according to illustrative embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Many systems and methods for detecting identity fraud use face recognition. With respect to security or counter fraud systems, face (or facial) recognition typically attempts to identify or verify a real, live person, from an image or video of the person. For example, face recognition is sometimes used along with, or instead of, other biometric means such as fingerprint or iris recognition, e.g., in an entrance to a secured facility.

Some systems use deep neural networks that are trained to detect identity fraud by indicating whether an image received from a source (e.g., a security camera placed at an entrance) is of a real, live person or of a printed image of the person, an image displayed on a screen of a computing device held in front of the security camera and the like.

As known in the art, training deep neural networks is considered more an art than a science. Designing and training a neural network requires making many seemingly arbitrary choices such as the number and types of nodes, the learning rate, selecting the training and test sets and so on. Therefore, many of the systems and methods known today fail to provide adequate results.

Some embodiments of the invention solve many of the challenges faced by the industry by, for example, employing an innovative way for collecting and selection of data sets (or dataset), e.g., training and test datasets as described, innovative ways of learning and generalizations as described, transforming and preprocessing input and other optimizations as further described herein.

Computerized, automated methods and systems for training a security system and/or providing a system capable of accurately identifying fraudulent attempts are presented. For example, computing device or system 100 may be, or may be included in a system that, provided with an initial input, teaches itself to identify fraudulent attempts, e.g., determine whether or not input received (e.g., image from a security camera) is of a real, live person.

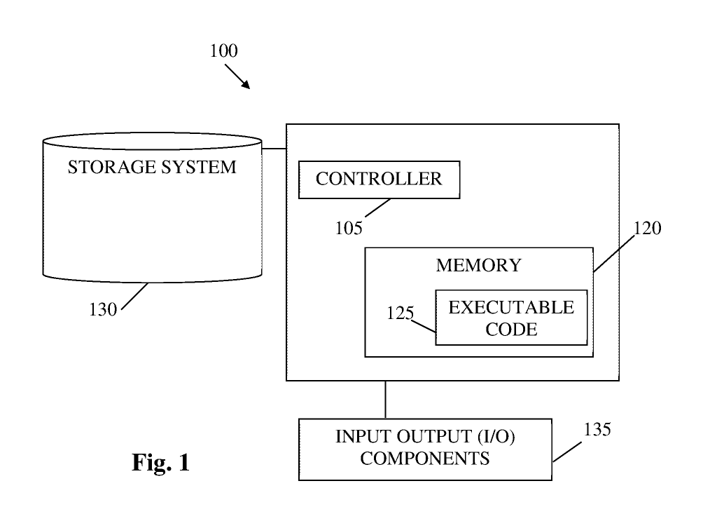

Reference is made to FIG. 1, showing a non-limiting, high-level block diagram of a computing device or system 100 that may be used to train a system and/or detect fraud according to some embodiments of the present invention. Computing device or system 100 may include a controller 105 that may be a hardware controller. For example, a hardware controller 105 may be, or may include, a central processing unit processor (CPU), a chip or any suitable computing or computational device. Computing system 100 may include a memory 120, executable code 125, a storage system 130 and input/output (I/O) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of, a system according to some embodiments of the invention.

In some embodiments, memory 120 is a hardware memory. For example, memory 120 may be, or may include, machine-readable media for storing software, e.g., a Random-Access Memory (RAM), a read only memory (ROM), a memory chip, a Flash memory, a volatile and/or non-volatile memory or other suitable memory units or storage units. Memory 120 may be or may include a plurality of, possibly different, memory units. Memory 120 may be a computer or processor non-transitory readable medium, or a computer non-transitory storage medium, e.g., a RAM. Some embodiments may include a non-transitory storage medium having stored thereon instructions which, when executed, cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

Executable code 125 may be executed by controller 105 possibly under control of an operating system. For example, executable code 125 may be an application that trains a system as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a hard disk drive, a CD-Recordable (CD-R) drive, a Blu-ray disk (BD), a universal serial bus (USB) device or other suitable removable and/or fixed storage unit.

Content may be loaded from storage system 130 into memory 120 where it may be processed by controller 105. For example, training and test sets may be loaded into memory 120 and used, by controller 105 to automatically train and test a system as further described herein.

In some embodiments, some of the components shown in FIG. 1 may be omitted. For example, memory 120 may be a non-volatile memory having the storage capacity of storage system 130. Accordingly, although shown as a separate component, storage system 130 may be embedded or included in system 100, e.g., in memory 120.

I/O components 135 may be, may be used for connecting (e.g., via included ports) or they may include: a mouse; a keyboard; a touch screen or pad or any suitable input device. I/O components may include one or more screens, touchscreens, displays or monitors, speakers and/or any other suitable output devices. Any applicable I/O components may be connected to computing device 100 as shown by I/O components 135, for example, a wired or wireless network interface card (NIC), a universal serial bus (USB) device or an external hard drive may be included in I/O components 135.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, a personal computer, a workstation, a server computer, a network device, or any other suitable computing device.

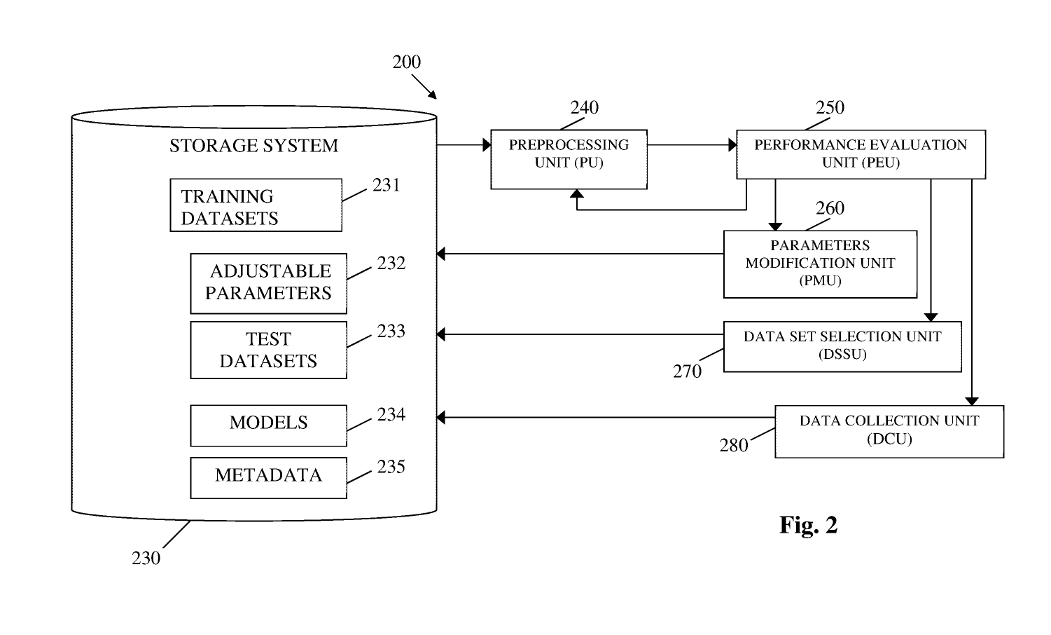

Reference is made to FIG. 2, an overview of a system 200 and flows according to some embodiments of the present invention. As shown, system 200 may include a storage system 230 that may be similar to storage system 130 described herein. As shown, storage system 230 may include training datasets 231, test datasets 233, metadata 235, adjustable parameters 232 and models 234 (collectively referred to hereinafter as training datasets 231, test datasets 233, adjustable parameters 232 and models 234 or individually as training dataset 231, test dataset 233, adjustable parameter 232 and model 234, merely for simplicity purposes).

Training and test datasets 231 and 233 may be, or may include, images or video clips. For example, in some embodiments, training and test datasets 231 and 233 include sets of images or video clips of people's faces. For example, in some embodiments, a test or training dataset contains millions (e.g., more than 10 million) images and movies that capture images of more than 100,000 people. Adjustable parameters 232 may include coefficients, weights, or other values or parameters of model 234 used by controller 105 to determine whether or not an image is of a real, live person.

Model 234 may be, may be, may include, or may define a set of connected nodes where an output of each node is based on inputs to the node (provided over connections to a plurality of other nodes) and weights, coefficients or other parameters or values associated with connections. For example, adjustable parameters 232 may include a set of connection related weights, coefficients or other parameters or values. Model 234 may include additional coefficients, parameters, thresholds or values. For example, a node in model 234 may have, or be associated with, a threshold, such that only if the aggregate input value to the node crosses the threshold the node produces an output signal or value. Accordingly, adjustable parameters 232 may include a set of thresholds. As described herein, an embodiment may automatically, iteratively, repeatedly, continuously and autonomously modify adjustable parameters 232 of or for model 234, e.g., in an iterative process that may be performed or repeated until the performance of a system (or of a model) is higher than a threshold. For example, in some embodiments, a training process may be repeated until a percentage of the images (in a set of input images) identified as related to fraud attempts is higher than a threshold. For the sake of simplicity, coefficients, parameters, thresholds or values of model 234 in adjustable parameters 232 are collectively referred to herein as coefficients.

As further shown in FIG. 2, a system may include a preprocessing unit (PU) 240, a performance evaluation unit (PEU) 250, a parameters modification unit (PMU) 260, a dataset selection unit (DSSU) 270 and a data collection unit (DCU) 280. System 200, or components of system 200, may include components such as those shown in FIG. 1. Where applicable, modules or units described herein, may be similar to, or may include components of, device 100 described herein. For example, each of PU 240, PEU 250, PMU 260, DSSU 270 and DCU 280 may be, or may include, a controller 105, a memory 120 and an executable code 125.

In some embodiments, DCU 280 collects data from any suitable source, e.g., the internet, and stores the collected data in training datasets 231 and/or in test datasets 233. Data collected by DCU 280 may include recordings of real, live people and/or recordings related to fraud (e.g., images of printed material, a video capturing a screen of a computer). Data collected by DCU 280 may include recordings (video clips) or images with standard and non-standard pose, positions, camera types resolutions and the like. For example, real recordings collected or obtained by DCU 280 may be images or video clips of real, live people and fraud recordings collected or obtained by DCU 280 may be images of images of people, images of printed pictures and the like. In some embodiments, DCU 280 may be connected to, or provided with input from, a Closed-Circuit Television (CCTV) placed in live sites (e.g., airports and the like). In some embodiments, DCU 280 may be provided with input that includes special scenarios, e.g., images obtained in the dark, images obtained in broad day light, images with various backgrounds and so on.

Data collected by, or provided to, DCU 280 may include live recordings or images from live sites, images of fraud and real recordings with standard and non-standard pose. Data provided to DCU 280 may include data created by capturing lots of far, middle and near faces tilted down and looking toward the cameras. DCU 280 may perform recording sessions oriented towards producing a very high variability of real data scenarios. For example, to collect images, a camera is moved around different locations in room, different rooms, corridors, outdoor, etc.

Collecting data, images or video clips may include production of fraud special cases, e.g., using different printers for printing a photo, obtaining images of people of different ethnicities, obtaining photos that don't have white borders, obtaining non-enrollment photos, obtaining photos with different kinds of backgrounds and so on. DCU 280 may collect images from different kinds of camera types and resolutions.

In some embodiments, to avoid a system and method from mistaking input related to fraud for real, live persons, movies from which real faces are excluded may be provided as input thus teaching a system to discriminate between real, live persons and pictures or movies of real, live persons.

For example, in some embodiments, images of real live persons may be printed on paper and the printed images may be provided as input to a system with the goal of training the system to identify whether input is an image of a real, live person or an image printed on paper or displayed on a screen of a tablet, smartphone or other device.

As shown by the arrow connecting blocks 250 and 280, DCU 280 may collect data based on input from PEU 250, for example, if PEU 250 fails a test run because it fails to identify images of paper prints as fraud, then DCU 280 may search the internet or a database for images of paper prints to be used for training a system.

Any data may be collected and used for training an embodiment. For example, in some embodiments, DCU 280 stores in training datasets 231 live recordings obtained by a camera while the camera is mobile in a site, or DCU 280 stores, in training dataset 231, images of printed content and/or images of a display of a computing device.

In some embodiments, PU 240 preprocesses images in datasets. Any operations performed by PU 240 as described herein may be performed on input received from DCU 280 and/or on images or other content in datasets 231 and 233. For example, some of the preprocessing operations performed by PU 240 as described herein may be executed on, or with respect to, data received from DCU 280, and some of the preprocessing operations performed by PU 240 as described herein may be executed on, or with respect to, creating and or updating data in datasets 231 and 233. For example, based on performance evaluation values, ranks, scores or levels received from PEU 250, PU 240 generates or updates training dataset 231 and/or test dataset 233, and generated or updated training dataset 231 and/or test dataset 233 are used for retraining a system.

A performance evaluation value, rank, score or level may be, for example, the percentage of images identified as related to fraud. For example, identifying only 62% of the images, in a set of input images, as related to fraud, may be considered a poor or low performance, and, identifying 92% of the images, in a set of input images, as related to fraud, may be considered a high score or rank.

Accordingly, an embodiment may operate in closed loop in which results of a first training session or run are used for a second training session or run in a process that may continue until performance of a system reaches a predefined or desired level. For example, an embodiment may automatically and iteratively perform a process involving: receiving a plurality of images related to fraud attempts; determining, for each of the images, whether or not the image is related to a fraud attempt; if a percentage of the images identified as related to fraud attempts is lower than a threshold then creating, modifying, adjusting or updating datasets (e.g., datasets 231 and 233) to produce new or updated datasets; and repeating the process using the new or updated datasets.

Accordingly, an embodiment may autonomously, automatically, repeatedly, periodically and/or continuously improve its performance by retraining itself using dynamically modified training and test datasets. In some embodiments, an automatic and/or iterative process as described may end or terminate when performance of a system reaches a predefined level. For example, the automatic, iterative process described herein may terminate or end when 95% of the images provided as input to PEU 250 are identified, by PEU 250, as related to fraud.

In some embodiments, PU 240 preprocesses images collected by DCU 280 so that they are uncorrelated, e.g., a first image in a dataset is of a first person in a first location, and a second, subsequent image in the dataset is of a second, different person in a second, different location. Preprocessing may include normalizing images, shifting objects in images, changing a scale, lighting and/or any other image attributes or parameters. Preprocessing performed by PU 240 may include any mathematical operations and/or image manipulations. For example, PU 240 may shuffle images in a set, center the input variables by subtracting the mean, normalize the input variables to standard deviation of 1 (e.g., so that they can be readily compared) and so on.

In some embodiments, PU 240 presents a set of images to a user and receives, from the user, indications of whether or not images shown are related to fraud. Presented with a set of images, the user can click on images that are of real, live people and leave unclicked or unchecked images related to fraud. For example, the user may leave unclicked or unchecked images of printed matter, images of images and/or other images that may be received by a system during an attempted fraud, e.g., images obtained during an attempt to gain access to a facility using a printed image of an authorized employee.

In some embodiments, preprocessing performed by PU 240 includes extracting portions of images, also known in the art as cropping. For example, using face recognition, PU 240 identifies a face in an image obtained by DU 280 and creates an additional or other image that includes only the face. Cropping of any other elements may be performed by PU 240, e.g., when used in a security system, PU 240 may crop portions of images that include weapons, or any other object of interest. Cropping by PU 240 may be automatic, e.g., provided with an image of an object or face, PU 240 may search for the face or object in datasets 231 and/or 233 and create images by cropping relevant portions from images in these datasets. In some embodiments, to preprocess images, PU 240 applies any image processing operations or techniques to images, e.g., resizing, anti-aliasing, down or up sampling, etc.

In some embodiments, the crop size used by PU 240 is automatically adjusted. For example, to optimize fraud detection, given the tradeoffs of computation time and overfitting, PU 240 may automatically adjust the crop size such that only faces are included in a cropped portion.

For example, regardless of an original size or image aspect (portrait or landscape), and regardless of an image ratio, a square crop is used by PU 240, and, therefore, no filtering at all of crops in the edges of the frame is necessary. In some embodiments, PU 240 performs a mirror extrapolation, for example, in the case where only part of a face is shown in an image, PU 240 completes the face using mirror extrapolation.

In some embodiments, PU 240 aligns images according to specific elements. For example, a center of an image may be determined, by PU 240, based on identifying human eyes and cropping may be done, by PU 240, around, or based on, the center of the image. Any image processing or other processing may be performed by PU 240, e.g., PU 240 may augment data in images, add/remove pixels to/from an image, change a resolution in an image, change a background in an image, transform colors or subtract RGB mean in an image, rotate or stretch an image and so on.

The color balance plays a significant part in the real/fraud decision. Accordingly, in preparing images for training and testing, PU 240 may randomly add colors to images, randomly change colors in images, randomly vary or modify RGB factors. For example, to simulate different white balance scenarios, PU 240 may randomly modify images' contrast and/or brightness, and so on.

Any image processing technique may be used by PU 240 and/or DSSU 270. For example, DSSU 270 may modify any attribute of one or more images as part of creating test and/or training datasets 233 or 231, and PU 240 may modify any attribute of one or more images in a dataset before providing the images as input to PEU 250.

As shown by the arrow connecting blocks 250 and 240, PU 240 may preprocess data based on input from PEU 250, for example, if PEU 250 fails a test because it fails to identify frauds in low resolution images then PU 240 may automatically down-sample images to be used for training a system in identifying frauds in low resolution images.

For example, some or even all of the images in datasets 233 or 231 may be associated with metadata that describes them (e.g., stored in metadata 235). For example, metadata associated with an image may include or indicate: a resolution, a camera type, background attributes, gender, age and ethnicity of a person in the image, a location (e.g., indoor or outdoor) and so on. In some embodiments, PU 240 may examine metadata of images that PEU 250 failed to identify as related to fraud, and, based on the metadata, PU 240 identifies the type, class or category of images that PEU 250 fails to identify as related to fraud. For example, based on the metadata of images that PEU 250 failed to identify as related to fraud, PU 240 may determine that PEU 250 fails to correctly identify images that are related to fraud if the images are of elderly females and/or with a low resolution and/or include a bright background. Having identified a specific type, class, characteristic or category of images that PEU 250 fails to correctly identify as related to fraud, an embodiment may select, or generate, images of the identified type, class or category for training a system.

For example, PU 240 may inform DSSU 270 that PEU 250 fails to correctly identify images of young males as related to fraud and DSSU 270 may select images of young males for training PEU 250. In another example, PU 240 identifies, as described, that PEU 250 fails to correctly identify images with low resolution as related to fraud and may, therefore, down-sample images before providing them to PEU 250, thus training PEU 250 with low resolution images. Accordingly, an embodiment may automatically and autonomously identify its own weaknesses and an embodiment may further address identified weaknesses by automatically and autonomously targeting identified weaknesses in an automated, machine learning and/or training process.

In some embodiments, PU 240 iteratively replaces the background of an image with a set of backgrounds or scenes, thus producing a number of images that differ in background or scene. For example, a set of images with the same face with different backgrounds may be generated, by PU 240, and provided as input to PEU 250 in order to train PEU 250 in order to find fraud attempts.

In some embodiments, PEU 250 includes a computing system that includes a number of interconnected processing elements each processing information based on its dynamic state. For example, PEU 250 may include a neural network system or model, e.g., model 234 may be a model used by a neural network system. As known in the art, a neural network system or model can be trained to identify objects in images. Generally, training a neural network system or model (e.g., model 234) includes providing the system with input and metadata, e.g., a set of images and a respective set of indications that may be stored in metadata 235. For example, input may include a set of images, and, for each image, the input may include an indication whether or not the image is related to fraud. Typically, following a training using a labeled or other dataset (e.g., training dataset 231), a system or model can provide the correct output or answer for new or yet unknown images, e.g., following a training, system 200 can correctly identify fraud attempts in images in test dataset 233 or, when deployed, system 200 can correctly identify fraud attempts in an entrance to a secured facility. Generally, to train a system, a human expert runs a neural network system with, or over, a dataset, evaluates the results, modifies coefficients in a model of the neural network system and reruns the training process. As described herein, some embodiments of the invention fully automate the training and testing process. Moreover, some embodiments of the invention may automatically, autonomously, iteratively, repeatedly and/or continuously train a system. As described, in some embodiments, a system automatically and continuously improves itself.

In some embodiments, given an input image, PEU 250 classifies the image as one of: an image of a real, live person whose image was captured, or an image related to fraud. As referred to herein, identifying, detecting or determining that an image is related to fraud includes or means classifying the image as related to fraud. Similarly, identifying, detecting or determining that an image is of, or is related to, a real, live person, includes or means classifying the image as related to a real, live person. Accordingly, where applicable, identifying, detecting, determining and classifying may be used interchangeably herein.

In some embodiments, PEU 250 computes a cost function that measures and quantifies the discrepancy between a correct or desired output and an actual output produced by system 200 when processing or evaluating the dataset. In some embodiments, PEU 250 computes an average cost function which is the average of the errors of system 200 over a set of inputs/outputs pairs in a training set, e.g., the average of the errors when processing training dataset 231. Generally, in the simplest setting, the learning problem includes finding the set and values of parameters or coefficients of a model that minimizes the average cost function.

In some embodiments, PEU 250 computes the error rate of a system as it would be in practice, when deployed in the field, e.g., in an airport or secured entrance. In some embodiments, PEU 250 computes the actual performance of system 200 based on processing test dataset 233 as described. In some embodiments, to compute or determine the actual performance of system 200, test dataset 233 may be created using a set of samples disjoint from (or different from) those in the training dataset 231. Otherwise described, the actual performance of system 200 may be determined using images unknown to, or yet unseen by, system 200.

In some embodiments, PEU 250 improves the process of calculating the cost function while maximizing the system's ability to generalize. In some embodiments, generalization techniques are used by PEU 250 to correct for the errors caused as a result of the selection of a dataset. For example, system 200 may, following a long training with one training dataset, learn the noise that is specific to the dataset, to solve this problem, PU 240 may separate a dataset into snapshots, e.g., sets of 100 images, and provide the snapshots to PEU 250 for training and evaluation such that PEU 250 is trained on each snapshot separately and attributes that are common to snapshots are ignored.

In some embodiments, PEU 250 improves the process of training a system or model 234 by at least one of: stochastics and batch learning, choosing training datasets with maximum information content, e.g., choosing, for each iteration or run, a sample or dataset that is most unfamiliar to the system. In some embodiments, PEU 250 uses a sigmoid activation function and chooses weights such that the sigmoid function is primarily activated in linear regions.

In some embodiments, during training, the input to system 200 is a fixed-size 224×224 RGB image. In some embodiments, PEU 250 includes a combination of one or more of following layers: convolution layer that convolves the input image with a set of learnable filters, each producing one feature map in the output image; a pooling layer that defines and performs a max, average, and/or stochastic pooling; a Spatial Pyramid Pooling (SPP) layer; a crop layer that performs cropping transformation, and inner product layer that fully connects layer; a dropout layer that excludes images from a set; an embedding layer for learning embeddings of one-hot encoded vector; and a set of normalization layers, such as Batch Normalization, that perform normalization over mini-batches and an activation neuron layer that is generally a set of element-wise operators that may take one bottom blob and produce one top blob of the same size, e.g., as taught by the Rectified-Linear and Leaky (ReLU) technique. In some embodiments, PEU 250 includes a set of loss layer, e.g., a softmax layer that computes the multinomial logistic loss of the softmax of its inputs.

In some embodiments, an input image is passed through a stack of convolutional layers in PEU 250. In some embodiments, filters in PEU 250 with different configurations having a very small receptive field designed to capture the notion of left/right, up/down and center are used. For example, in one of the configurations, a 1×1 convolution filter is used, which can be seen as a linear transformation of the input channels (followed by non-linearity). Accordingly, the convolution stride is fixed to 1 pixel; the spatial padding of the convolution layer input may be such that the spatial resolution is preserved after convolution, i.e., the padding is 1 pixel for 3×3 convolution layers. In some embodiments, spatial pooling is carried out by five max-pooling layers. In some embodiments, max-pooling is performed over a 2×2 pixel window, with a stride of 2.

In some embodiments, a stack of convolutional layers (each having a different depth in different architectures) is followed by three Fully-Connected (FC) layers. The final layer may be the soft-max layer. In some embodiments, the configuration of the fully connected layers is the same in all networks. In some embodiments, all hidden layers are equipped with the rectification (ReLU) non-linearity. In some embodiments, PEU 250 uses different configurations of convolution layers. In some embodiments, PEU 250 automatically increases/decreases the depth of the configurations during a training or optimization phase. Of course, as more layers are added, the run time and memory consumption increases, and, accordingly, PEU 250 may add and remove layers according to improvement in detection of fraud and according to run time and memory consumption. For example, provided with constraints on run time and/or memory consumption, PEU 250 uses different configurations of convolution layers until the best result for the given run time and memory constraints.

In some embodiments, PEU 250 determines that a set of images is of a real face and not of one or more images by identifying that a person in the image is moving (e.g., with respect to a background in the image) and/or by one of: identifying changing facial expressions, detecting face movements, identifying perspective changes, identifying relative lighting changes etc. For example, PEU 250 examines changes in a face size, location and/or angle in an image frame to detect fraud. For example, if the size or location of a face is constant in a set of images, then PEU 250 deduces that the face is printed on paper or is presented by a tablet, since the face of a real, live person typically moves in an image.

An embodiment may crop similar portions of two or more images of an object, compare a distance between feature vectors in the portions to a threshold, and, if the distance is below the threshold, determine the two or more images are related to a fraud attempt. As known in the art and referred to herein, a feature vector is a vector of numerical features that represent an attribute or object in an image.

For example, in some embodiments, PEU 250 extracts a central crop area of 80×80 from a set (or train) of images (or frames) in a sequence of frames (e.g., in a video clip or a set of images obtained using burst-shot as known in the art), and, if the distance between a set of feature vectors in the set or train is above a threshold, then PEU 250 determines that the images in the set are of a real person; otherwise, if the distance between the set of feature vectors in the set or train is below a threshold, then PEU 250 determines that the images are related to a fraud, e.g., the images are of a printed page, printed shirt and the like. For example, identifying an eye blink can cause PEU 250 to determine the images are of a real person, while lack of eye blinking in a set of images can cause PEU 250 to determine that the images are related to fraud.

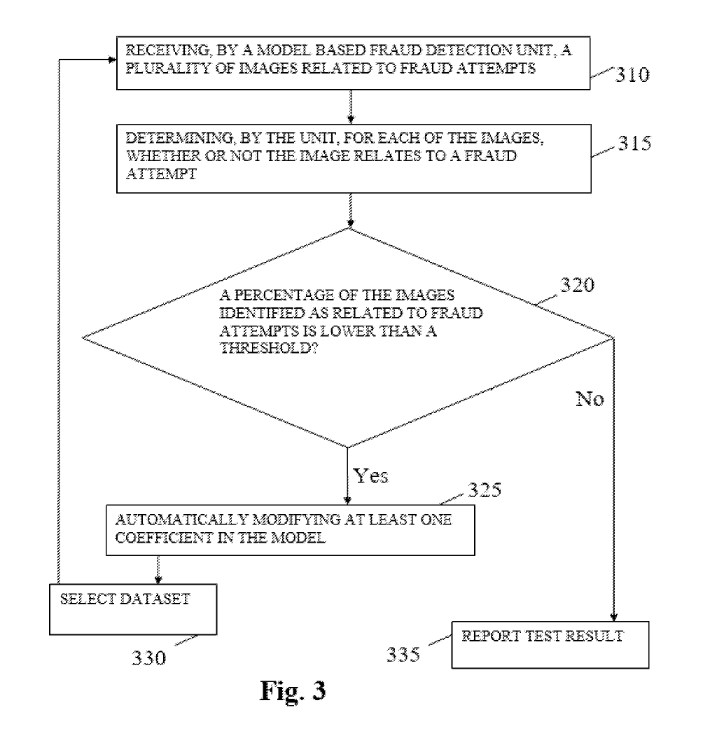

Reference is made to FIG. 3, which is a flowchart of a method according to illustrative embodiments of the present invention. As shown by block 310, a plurality of images related to fraud attempts may be received by, or provided as input to, a model-based unit. For example, PEU 250 receives images in test dataset 233. As shown by block 315, the receiving unit may determine for each of the images, whether or not the image is related to fraud. For example, using a model 234 as described, PEU 250 examines each of the images and decides whether the image is of a real person whose image was obtained or the image is related to fraud, e.g., the image is of a printing of an image.

As shown by block 320, an embodiment may determine whether or not the percentage or ratio of images identified as related to fraud attempts is lower or higher than a threshold. For example, PEU 250 may count and record the number of images it identified as related to fraud and may count and record the number of images processed. For example, by dividing the number of images identified as related to fraud by the number of images processed (e.g., the number of images in a dataset provided to PEU 250), a ratio or percentage may be calculated by PEU 250.

As shown by block 325, if the percentage or ratio is lower than a threshold (e.g., indicating insufficient accuracy), then a flow may include automatically modifying one or more parameters, threshold, values or coefficients in, or of, model 234 used by PEU 250.

As shown by block 330, a flow may include selecting a dataset before repeating the flow of receiving images, determining relation to fraud and checking the percentage or success rate as described with reference to blocks 310, 315, 320 and 325. For example, PEU 250 may inform DSSU 270 (e.g., using identification numbers or codes (IDs)) which of the images in a first dataset were identified as related to fraud, and DSSU 270 may exclude those images from the first dataset to create a second dataset, e.g., the second dataset includes all the images that PEU 250 failed to identify as related to fraud.

Automatically modifying datasets for test or training runs may include any modification based on any input. For example, each of the images in a dataset may include, or be associated with, metadata that may include any relevant information. For example, metadata of an image in datasets 231 and 233 includes a description of objects in an image (e.g., human, table, tree), lighting, resolution, color attributes or any other imaging or other values or attributes of the image. Accordingly, when DSSU 270 receives a report from PEU 250 indicating which of the images PEU 250 failed to identify as related to fraud, DSSU 270 can, based on metadata as described, determine classes of images that PEU 250 fails to process correctly. For example, DSSU 270 can identify that PEU 250 fails to identify fraud in images with a certain (possibly low) resolution or in images with very bright light. DSSU 270 can select specific datasets based on weaknesses of PEU 250, e.g., if PEU 250 fails due to bright light, then DSSU 270 selects more images with bright light for training model 234 used by PEU 250. Accordingly, by dynamically and automatically generating datasets and/or by dynamically and automatically selecting datasets to provide to PEU 250, system 200 can autonomously, continually and/or repeatedly train and retrain itself until it reaches satisfactory performance. As shown by the arrow connecting blocks 330 and 310, after modifying a model 234 and/or selecting or generating a dataset, the flow may be repeated, e.g., until the percentage or ratio checked as shown by block 320 is higher than a threshold when, as shown by block 335, an embodiment may provide a test result report. For example, as shown by block 335, PEU 250 may report, e.g., on a screen of a computer, the percentage or ratio, the total number of images processed, the time spent processing and so on.

In some embodiments, a model based fraud detection unit (e.g., PEU 250) receives a plurality of images related to fraud attempts, and the unit determines, for each of the images, whether or not the image is related to a fraud attempt, and, if the percentage or ratio of the images identified as related to fraud attempts is lower than a threshold, then the unit automatically modifies at least one coefficient in the model (e.g., automatically modifies at least one coefficient adjustable parameters 232 for model 234). The unit may repeat the steps of receiving images, determining a ratio or percentage of identified frauds and automatically modifying parameters, values or coefficients of model 234 until the percentage of images identified as related to fraud attempts is higher than a threshold. For example, system 200 may continuously or repeatedly receive images related to fraud (e.g., from a dataset that includes only images of fraud attempts as described), determine a ratio or percentage of identified frauds and automatically modify parameters, values or coefficients of, or for, a model (e.g., adjustable parameters 232 for model 234) until at least 85% of the images provided as input are identified as related to fraud. For example, after PEU 250 analyzes a set of images in a test dataset, it reports to PMU 260 the percentage or number of images identified as related to nodes; if the number or percentage is lower than a threshold, PMU 260 modifies one or more coefficients or parameter values in adjustable parameters 232, and the parameters are loaded into a model 234 used by PEU 250 and the process repeats itself, e.g., until the percentage or number reported to PMU 260 is below a threshold.

In some embodiments, a system and method are trained for identifying images related to fraud as described. In some embodiments, a system and method are trained for identifying real, live persons. For example, PU 240 may provide PEU 250 with a plurality of images of real, live persons, e.g., in training datasets 231, PEU 250 may use model 234 to determine, for each of the images, whether or not the image is of a real, live person, and, if a percentage or ratio of the images identified as images of real, live persons is lower than a threshold, then PMU 260 may automatically modify at least one coefficient of, for, or used by, the model (e.g., model 234), and the process may be repeated until the percentage of the images identified as images of real, live persons is higher than a threshold.

Any operation unit or logic used for determining if a percentage of images identified as related to fraud attempts is lower than a threshold may be used in determining if a percentage or ratio of images identified as images of real, live persons is lower than a threshold. For example, DSSU 270 may create or select a dataset that includes images that were not identified as images of real, live persons, and PU 240 may provide the selected or created dataset as input to PEU 250 as described. Accordingly, datasets for training or testing a system may be dynamically created or updated based on a performance of the system, for example, if DSSU 270 determines that PEU 250 fails identifying fraud in images with males more than it does in images with females, then DSSU 270 may select or create a training dataset that includes more females than males. Otherwise described, a system automatically identifies its problems or weaknesses and automatically trains or improves itself by addressing the identified problems or weaknesses, e.g., by generating training datasets specifically designed to resolve a specific identification problem.

As described, preprocessing may be performed, e.g., on images in a selected dataset. Generally, an embodiment iteratively, periodically, repeatedly or continuously execute training or testing sessions (also referred to herein and in the art as “run” or “runs”). For example, a run or training sessions includes some or all of the elements or steps of: collecting data by DCU 280; selecting a dataset for the run by DSSU 270; modifying parameters and values for a model by PMU 260; preprocessing of content in a selected dataset by PU 240; and performing an evaluation, training or testing and/or performing processing in the field by PEU 250.

An embodiment may iteratively, periodically, repeatedly or continuously preprocess content, e.g., modify attributes of images in a dataset. For example, based on detecting or determining that PEU 250 fails to correctly identify fraud in images with high resolution in a first run, PU 240 may increase a resolution (e.g., up-sample) of images before providing them as input to PEU 250 in a second or subsequent run or session.

A dataset may include any number of one or more images. For example, an embodiment may repeat training itself until, provided with a single image as input (e.g., a dataset the includes one image), the embodiment correctly determines whether or not the single image is of a real, live person. For example, when generating or reselecting datasets, DSSU 270 keeps removing or excluding, from a dataset, images that were correctly identified or classified by PEU 250 until PEU 250 correctly classifies all images in a dataset; next, new images, or images yet unknown to, or yet unprocessed by, system 200, may be obtained by DCU 280, new datasets may be generated, and the system may repeat the entire process described herein.

In some embodiments, e.g., when used for a security system, border control and the like, a system may be connected to a database that includes images of suspects, authorized or known personnel or other specific people and, after determining an image is of a real, live person, an embodiment may find, in a database, information related to the person and may perform at least one action based on the information. For example, PEU 250 may determine that an image received from a camera is of a real, live person (that is, the image is not a fraud attempt), may search for the image in a database, and, based on metadata associated with the image in the database, may perform an action. For example, the metadata of an identified person may indicate the person is an employee authorized to enter an office, and, in such case, the action performed by PEU 250 may include opening a door, e.g., by sending a message to a smart-lock, or, in other cases, PEU 250 may sound an alarm when metadata of an identified person indicates cause for alarm.

In some embodiments, performing at least one action by PEU 250 as described may be based on identifying the same person in one or more previously obtained images that were identified as related to a fraud attempt. For example, in operation, e.g., when deployed at an entrance to a secured location, PEU 250 stores images classified as related to fraud, e.g., in storage system 130, and, when provided with an image from a camera at the entrance, PEU 250 may compare or match the input image to images stored as described, and, if a match is identified or found, PEU 250 may perform one or more actions as described.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method comprising:
a. receiving, by a model-based fraud detection unit, a plurality of images related to fraud attempts;
b. determining, by the unit, for each of the images, whether or not the image is related to a fraud attempt;
c. if a percentage of the images identified as related to fraud attempts is lower than a threshold then automatically modifying at least one coefficient in the model; and
d. repeating steps a, b and c until a percentage of the images identified as related to fraud attempts is higher than the threshold.

2. The method of claim 1, further comprising selecting, for repeating steps a, b and c, a subset of the plurality of images, the subset including images that were not identified as related to fraud attempts.

3. The method of claim 1, further comprising:
e. providing, to the detection unit, a plurality of images of real, live persons;
f. determining, by the unit, for each of the images, whether or not the image is of a real, live person;
g. if a percentage of the images identified as images of real, live persons is lower than a threshold then automatically modifying at least one coefficient in the model; and
h. repeating steps e, f and g until a percentage of the images identified as images of real, live persons is higher than the threshold.

4. The method of claim 3, further comprising selecting, for repeating steps e, f and g, a subset of the plurality of images, the subset including images that were not identified as representing real, live persons.

5. The method of claim 1, further comprising, prior to repeating steps a, b and c, modifying attributes of at least some of the plurality of images.

6. The method of claim 1, further comprising, repeating steps a, b and c until, provided with a single image, the fraud detection unit correctly determines whether or not the single image is of a real, live person.

7. The method of claim 1, further comprising:
determining an image is of a real, live person;
finding, in a database, information related to the person; and
performing at least one action based on the information.

8. The method of claim 7, further comprising performing the at least one action based on identifying the person in one or more previously obtained images related to a fraud attempt.

9. The method of claim 3, further comprising training the detection unit by providing, to the detection unit, live recordings obtained by a camera while the camera is mobile in a site.

10. The method of claim 1, further comprising training the detection unit by providing, to the detection unit, images of printed content.

11. The method of claim 1, further comprising training the detection unit by providing, to the detection unit, images of a display of a computing device.

12. The method of claim 5, further comprising, wherein modifying attributes of at least some of the plurality of images includes randomly changing at least one of: red, green and blue (RGB) factors, contrast and brightness.

13. The method of claim 1, wherein determining whether or not the image is related to a fraud attempt includes:
cropping similar portions of two or more images of an object;
comparing a distance between feature vectors in the portions to a threshold; and
if the distance is below the threshold then determining the two or more images are related to a fraud attempt.

14. A system comprising:
a model-based fraud detection unit configured to:
a. receive a plurality of images related to fraud attempts;
b. determine for each of the images whether or not the image is related to a fraud attempt;
c. if a percentage of the images identified as related to fraud attempts is lower than a threshold, automatically modify at least one coefficient in the model; and
d. repeat steps a, b and c until a percentage of the images identified as related to fraud attempts is higher than the threshold.

15. The system of claim 14, further comprising a data selection unit configured to select, for repeating steps a, b and c, a subset of the plurality of images, the subset including images that were not identified as related to fraud attempts.

16. The system of claim 14, further comprising:
e. providing, to the fraud detection unit and by a data set selection unit, a plurality of images of real, live persons;
f. determining, by the fraud detection unit, for each of the images, whether or not the image is of a real, live person;
g. if a percentage of the images identified as images of real, live persons is lower than a threshold, automatically modifying, by a parameters modification unit, at least one coefficient in the model; and
h. repeating steps e, f and g until a percentage of the images identified as images of real, live persons is higher than the threshold.

17. The system of claim 16, further comprising a dataset selection unit configured to select, for repeating steps e, f and g, a subset of the plurality of images, the subset including images that were not identified as representing real, live persons.

18. The system of claim 14, further comprising, prior to repeating steps a, b and c, modifying, by a preprocessing unit, attributes of at least some of the plurality of images.

19. The system of claim 14, further comprising, repeating steps a, b and c until, provided with a single image, the fraud detection unit correctly determines whether or not the single image is of a real, live person.

20. The system of claim 14, wherein the fraud detection unit is further configured to:
determine an image is of a real, live person;
find, in a database, information related to the person; and
perform at least one action based on the information.
